(19) United States
(12) Patent Application Publication
(10) Pub. No.: US 2009/0305070 A1
(43) Pub. Date: Dec. 10, 2009

(54) PROCESS FOR PULSED UV CURING OF COATINGS ON WOOD

(75) Inventors: Vittorio Belluz, Charlotte, NC (US); Alessandro Pupillo, Venice, CA (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: DELLE VEDOVE USA, INC., Charlotte, NC (US)

(21) Appl. No.: 12/092,915

(22) PCT Filed: Nov. 16, 2006
(86) PCT No.: PCT/US06/44609

§ 371 Date: Oct. 6, 2008

Related U.S. Application Data
(60) Provisional application No. 60/736,834, filed on Nov. 16, 2005.

(51) Int. Cl. B32B 21/04; B05D 3/02; B05C 11/00

(52) U.S. Cl. 428/537.1; 427/508; 118/620

(57) ABSTRACT

A process and apparatus for curing UV-curable coatings present on a wood substrate. The process and the apparatus include the use of pulsed UV lamps to expose a substrate to curing UV light under conditions that do not substantially raise the temperature of the substrate undergoing curing.

### BACKGROUND OF THE INVENTION

1. Field of the Invention

The invention relates to a process that includes curing UV-curable coatings on wood using pulsed UV light. The invention includes an apparatus for forming cured coatings. The invention further relates to coatings formed by the process and substrates covered with the cured coatings formed by the process.

2. Description of the Related Art

Coatings for wood surfaces have been known for years. Coatings may be formed on wood surfaces by many processes. For example, a liquid coating may be applied to a wood surface and dried to form a solid coating on the wood surface. Improved coatings can be obtained by coating a wood surface with a polymerizable material, then carrying out polymerization to form a network of interbonded molecules, e.g., to form a cured coating. Such cured coatings can be formed by applying one or more materials in liquid or powder form to a wood surface. The thus obtained coated surface is then subjected to polymerization to cause a reaction which leads to the formation of the interbonded (e.g., crosslinked and/or polymerized) molecular structure on the substrate (e.g., wood) surface.

Cured coatings have numerous advantages over other coatings. Because cured coatings have an interbonded molecular network, significant improvements in the coatings' physical and chemical properties such as improved resistance to photodegredation, improved impact resistance, improved abrasion resistance and washability can be obtained.

Curing may be undertaken chemically or physically. Chemical curing may include incorporating a curing agent into the coating material applied to a surface. The curing agent functions to catalyze or initiate a curing process which thereby forms an interbonded molecular network. Physical processes include exposing a coated surface to a form of energy such as light or other electromagnetic or radiation energy, to thereby initiate a chemical reaction which leads to the formation of the cured coating.

Curing initiated by ultraviolet (UV) light can be used for coating materials that contain a functionality that decomposes upon exposure to UV to generate a radical species necessary to initiate and propagate the chemical reaction and thereby form an interbonded molecular network. UV curing has many advantages including the ability to cure powders, a low overall cost, and the short time within which a cure can be completed. Because UV-cured coatings can be obtained from UV-curable compositions that are free of any diluent, significantly lower quantities of the coating materials are needed and the release of hazardous materials can be avoided.

The use of UV-curable compositions on wood surfaces may lead to complications which may affect the quality of the coating. Conventional processes for curing UV-curable compositions coated onto wooden substrates involve continuously exposing the coated substrate to UV light. UV light sources usually generate light in other wavelengths such as in the visible and infrared (IR) regions. Because the intensity of the UV light must be high in order to achieve complete cure, the intensity of any other wavelengths of light inadvertently produced by the UV source may also be substantially greater than what is encountered in nature. Intense IR light causes the temperature of the substrate to rise. In the case of a wood substrate, the heating may be so intense that combustion of the substrate may occur. More commonly it is observed that excess heating of wood substrates leads to the formation of resins on the surface of the wood substrate (e.g., resin bleeding).

Such resins are naturally derived from the wood. In certain woods such as pine wood, the amount of resin present in the wood is substantial. Thus, UV curing that heats the substrate may lead to the formation of substantial amounts of resin on the wood surface underneath the coating materials. Because wood-derived resins are organic resins they may mix with or dissolve the coating materials under which they form, resulting in incomplete curing of the coating material during UV exposure. Later in the life of the coated substrate, this area of incomplete curing may lead to defects such as peeling, flaking, etc.

In addition to the formation of resin, gases may evolve from the wood during continuous exposure to UV light. As gases evolve from a wood surface they may be trapped underneath a cured coating. The presence of the gas between the coating and the wood substrate may lead to peeling such as orange peel. This problem can be especially severe in substrates that are coated and cured on all sides, for example, moldings.

### SUMMARY OF THE INVENTION

Accordingly, it is an object of the present invention to provide a process for curing UV-curable coating materials present on the surface of wood in a manner such that the substrate remains cool and does not desorb gases or resins.

A further object of the invention, is the formation of a coating layer which does not exhibit the peeling and/or degradation observed in coatings wherein degassing and/or resin desorption from the substrate has occurred.

A further object of the invention is a process for preparing a coated wood substrate and the coated wood substrate obtained therefrom.

A further object of the invention is to provide an apparatus for curing wood substrates on a continuous or batch basis.

### DETAILED DESCRIPTION OF THE INVENTION

In one aspect of the invention a wood or wood-containing substrate is coated with a UV-curable coating material and subsequently cured by exposure to UV light or energy. The UV-curable coating material typically contains photochemically crosslinkable groups such as polymerizable monomers and/or polymerizable oligomers. UV-curable coating materials include materials such as acrylates, urethane acrylates, prepolymers thereof and/or polyfunctional derivatives thereof. Preferably, the coating material contains a polymerizable acrylate functionality.

Preferably the coating materials contain a UV photoinitiator that is responsive to the wavelength of UV light provided by the UV lamps mentioned herein, e.g., high UV energy in the region of greater than 200 nm, alternatively greater than 160 nm, alternatively greater than 240 nm, alternatively greater than 140 nm. UV photoinitiators such as the LX and DX photoinitiators supplied by Cytec and/or or Ciba Irgacure 784 from Ciba. UV photoinitiators may include one or more of a free radical type and/or a cationic type. Free radical UV photoinitiators include alpha-hydroxy aryl ketone-type compounds such as 1-hydroxycyclohexyl phenyl ketone (e.g., Irgacure 184 from Ciba Specialty Chemicals), 2-benzyl-2,N,N-dimethylamino-1-(4-morpholinophenyl)-1-butanone (e.g., Irgacure 369 from Ciba Specialty Chemicals), 2-hydroxy-2-methyl-1-phenyl propane-1-one (e.g., Darcur 1173 from Ciba Specialty Chemicals), a 50:50 blend of 2-hydroxy-2-methyl-1-phenyl propane-1-one and 2,4,6-trimethylbenzoyldiphenylphosphine oxide (e.g., Darocur 4265 from Ciba Specialty Chemicals), 4-(2-hydroxyethoxy)phenyl-(2-propyl)ketone (e.g., Darocur 2959 from Ciba Specialty Chemicals), an alpha-amino acetophenone derivative such as Irgacure 369 from Ciba Specialty Chemicals, a mixture of 1-hydroxycyclohexyl phenyl ketone and benzophenone such as Irgacure 500 from Ciba Specialty Chemicals, 2,2-dimethoxy-2-phenylacetophenone (e.g., Esacure KB-1 from Sartomer), and trimethylbenzophenone blends (such as Esacure TZT from Sartomer). Cationic UV photoinitiators include triarylsulfonium hexafluoroantimonate salts such as UVI-6974 from Union Carbide, and mixed triaryl sulfonium hexafluorophosphate salts such as UVI-6990 from Union Carbide.

The coating materials may further contain any number of pigments or additives such as those commonly found in coating compositions. For example, the coating materials may contain pigments and/or dyes. The pigments may be inorganic or organic pigments dispersed within the coating material. Inorganic pigments may contain for example titanium dioxide or other mineral-based pigments or phthalocyanine-based organic pigments. Organic dyes, soluble in the UV-curable coating materials may be present alone or in combination with one or more pigments.

Wood substrates that may be coated with the process include substrates that are cut from virgin stock wood, particle board, paste board, extruded composites that contain wood and/or a wood substitute such as cellulose fibers and a matrix such as a matrix binder or polymer, wood substrates having a previously applied coating, and laminated wood surfaces.

Wood in any form may be coated and cured in the claimed process, such as cut lumber, etc. Flat panels are advantageously cured on one or more sides of greatest surface area. In one embodiment of the invention, the wood is first heated and degassed, for example subjected to vacuum or placed in an atmosphere of dry inert gas, before the application of UV-curable materials.

The UV light used in the process to cure the UV-curable material is a pulsed UV light. The pulsed UV light may include visible light. Preferably, the pulsed UV light does not include IR light or includes IR light in an intensity substantially less than the UV light. The UV lamp used to provide pulsed UV light may have a cut-off point of 370 nm for UV energy and include the visible spectrum up to 700 nm. Other UV lamps may be used including UV lamps having a spectral UV cut-off point of 240 nm, 190 nm, 160 nm or 140 nm and may include the visible spectrum.

Peak power irradiation of the pulsed UV light is preferably greater than 100 watts/cm². More preferably the peak power is greater than 400 watts/cm², even more preferably 750 watts/cm² or greater, even more preferably 1375 watts/cm² or greater, more preferably 1800 watts/cm² or greater, or any value, range, or sub-range between the stated values. The intensity of the pulse of UV and/or visible light produced by the UV light is many times greater than the intensity of light produced by a continuous UV lamp. For example, pulsed UV light may have a peak power that is 1,000 times the peak power of continuous UV light.

The UV lamp utilized for pulsed UV curing may include UV energy in a broad spectrum with cutoff points such as those described above. Once past the cutoff point, the pulsed UV lamp provides a broad and even distribution of energies over the remaining UV spectrum. Thus, it is not necessary to use a plurality of UV lamps in comparison to processes which utilize continuous UV light which may need more than one UV lamp to cover the entire desired spectrum of UV energy.

The energy of the pulsed UV lamp is delivered in short bursts resulting in an overall energy savings. In comparison to a curing process utilizing a continuous UV source, a pulsed UV lamp may provide an energy savings of 50% or more.

The on/off time of each pulse of UV light is about 2 microseconds. Preferably each pulse of UV light is from 0.1 to 10 microseconds, more preferably from 0.5 to 5 microseconds, even more preferably from 1 to 4 microseconds. Lamps such as the RC-1002, RC-742/747, RC-250B, RC-500B, and/or RC-600 from Xenon of Wilmington, Mass. are examples of pulsed UV light sources that may be used in the process. Other lamps such as lamps from Steribeam of Kehl, Germany may be used, for example, lamps and/or lamp systems SBS/Ind-xLM and LTx. Pulsed UV lamps based on laser technology or laser beams may also be used, such as AVIA™ Thor™ systems from Coherent, Inc. and their Q-switched counterparts. UV laser systems from Lambda physik including the XTS and extreme UV system supplied through XTREME technologies GmbH, of Germany.

The process preferably excludes continuously irradiating a substrate with UV light.

The number of UV pulses to which a coating material is exposed is determined by the degree of curing and/or the chemical properties desired in the finished coating. Total exposure times may range from fractions of a second to minutes. Because the actual exposure to UV light is only during the brief period of a UV pulse, even for a long exposure the actual exposure to UV light is the cumulative length of the UV pulse. For example, an exposure for one second using a pulse pattern of a 2 microseconds UV pulse followed by an 8 microsecond delay may provide an actual UV exposure of only 0.2 seconds. The delay and length of the UV pulse can be changed as necessary. A delay between UV pulses may range from milliseconds to seconds. Preferably, the duration or delay between pulses is a factor of from 5 to 100 times the period of the UV pulse. More preferably, the delay is from 10 to 20 times the length of the UV pulse.

The wood-containing substrate coated by the process may be in any form. In a particularly preferred form, the wood is in the form of a molding to which an uncured UV-curable coating material is applied on all sides. The molding is exposed to pulsed UV light around its entire periphery to cure the UV-curable material on all exposed surfaces. A molding is a piece, of wood which has been shaped by cutting, milling, joining or lathing. Typically, a molding is visible from many angles and it is important that at each angle of visibility the cured coating provide a uniform appearance.

In the process of the invention a substrate such as a molding, for example a molding having an infinite linear length and definite dimensions of height and width is continuously drawn through a chamber in which one or more pulsed UV lamps is positioned. The substrate, to which a UV-curable material has been applied, is continuously pulled through the chamber in the vicinity of the pulsed UV lamps so that each surface of the substrate to which the UV-curable coating material has been applied is exposed to pulsed UV light. It is not necessary that all areas of the UV-curable coating material are exposed to an equal amount of UV pulsed light. It is only important that each area be exposed to the minimum quantity of pulsed UV light needed to initiate and complete the reaction to form a completely cured interbonded molecular network on the surface of the substrate.

In preferred embodiment of the invention the wood substrate is exposed to pulsed UV light in a manner that does not lead to a temperature increase of the substrate. For example, the UV-curable coated substrate may have a temperature increase of less than 5° C. measured at the interface between the surface of the wood substrate and the surface of the coating which is in contact with the surface of the substrate. In a particularly preferred embodiment of the invention, the temperature of the substrate measured at the interface of the substrate surface and the coating surface is increased by no more than 20° C. due to exposure to the pulsed UV and/or visible light. Even more preferably, the temperature increase at the interface between the wood substrate and the UV coating is 10° C. or less, more preferably 5° C. or less and most preferably there is no measurable temperature increase.

The wood substrate may be moved through the chamber at a speed corresponding with the pulse length and delay between pulses in order to expose the coating materials present on the surface of the substrate with sufficient UV light in order to undergo complete reaction and curing (e.g., crosslinking). The process may include a step of applying UV-curable coating materials onto the substrate in advance of exposure to the pulsed UV light. For example, the UV-curable coating material may be applied as a liquid by spraying the liquid onto the substrate, by electrospray of a powder onto the substrate, by dipping the substrate through a bath of liquid and/or powder containing the UV curable coating material or other method known in the art for applying the UV-curable coating materials to the surface of the substrate. If desired, multiple applications and curing cycles may be carried out on a single wooden substrate with one or more UV-curable coating material that may be the same or different. For example, in a first step a UV-curable coating material is applied onto a substrate, the thus coated substrate is exposed to pulsed UV light to cure the material present thereon and thereby form, for example, a primed surface. The thus primed wood substrate may receive a further coat of a UV-curable coating material or other material. If a UV-curable coating material is applied in a subsequent step, it may be cured in the same or a different coating chamber having a pulsed UV lamp.

In another preferred embodiment, the process is used to cure a coated flat panel. The flat panel may be a cardboard, veneer-covered, laminated and/or MDF board. The process can be used to cure an adhesive present on a thin film between the wood substrate and the film. The thin film may be a paper or flexible cellulosic or polymer-based film. The process may also be used to permanently adhere a film to a wood substrate by embedding the film into a coating present on the surface of the substrate. Preferably the film is at least partially transparent to UV light. Thus, the process can be used to top-coat a panel.

The amount of UV-curable coating material that is applied onto a wooden substrate may vary and may depend at least in part on the desired thickness of the resulting cured coating. Coating thicknesses may range from 0.1 to 1,000 μm, preferably from 1 μm to 10 mm, preferably from 10 μm to 5 mm, most preferably from 100 μm to 1 mm in thickness. Other preferred thicknesses include the range of 0.01 mm to 1 mm; 0.05 mm to 0.9 mm; 0.01 mm to 0.8 mm; 0.1 mm to 0.5 mm. Thicknesses of from 0.5 mil to 2 mil are also preferred, more preferably 1 mil to 2 mil.

In a further embodiment of the invention a first UV-curable coating material is applied to a wooden substrate. A second UV-curable coating material is applied on top of the first UV-curable coating material before any curing has taken place. Subsequent exposure of the wooden substrate having a first layer of a first UV-curing coating material and a second layer of a UV-coating material present thereon, provides a wooden substrate having two distinct layers that are blended into one another at the interface of the first and second UV-curable coating materials.

The process of the invention provides many advantages. One advantage is the ability to maintain the temperature of the wooden substrate at a substantially lower temperature than would otherwise be obtained in a process wherein curing is carried out by exposure to a continuous UV source. A lower substrate temperature reduces or eliminates the bleeding (e.g., formation) of resin on the surface of the substrate. Lower substrate temperatures also reduce any out-gassing, escape or release of gases which may occur when the substrate is heated.

Because little or no resin is bled onto the surface of the substrate, the coating prepared by pulsed UV curing of the UV-curable coating materials is in continuous contact with the wooden substrate. For example, the cured coating is in uninterrupted contact with the cellulosic material of the wooden substrate throughout the entire length and/or dimensions of the substrate. Such a degree of contact minimizes or eliminates orange peel or delamination of the cured UV-curable coating material from the surface of the substrate. Such a cured coating may contain only those materials present in the original UV-curable coating material applied onto the wooden substrate. Thus, contamination of the cured coating with the resin materials or other materials that might otherwise bleed from a heated substrate is eliminated in the inventive process. This is an especially important effect for wood substrates that contain large amounts of resin, such as pine.

Because the pulsed UV lamp does not heat the substrate or heats the substrate only to a minor degree, thin substrates that may otherwise warp or bend under the influence of heat generated by a continuous UV lamp cure, may be cured in the inventive process without warping or other heat deformation. Because there is no or only minor heat deformation during curing, the presence of strain within the cured coating is eliminated entirely or substantially reduced in comparison to coatings which undergo flexing or deformation during the curing process. The coating therefore has improved physical properties including abrasion resistance and flexibility.

The process may be carried out on substrates that contain multiple layers of material adhered to one another. For example, two layers of a wood-based material can be cured without deformation or delamination. This is particularly important if the various layers are materials that may respond differently to heat exposure, due to different thermal expansion properties.

The process permits the curing of UV-curable coating materials containing large amounts of opaque or darkly pigmented materials. The greater intensity of a UV pulse in comparison to the intensity of UV light obtained by continuous exposure results in greater UV penetration and lower build-up of heat and consequently the time necessary to cure a substrate may be further reduced.

The process may be carried out in a continuous apparatus containing a curing tunnel that protects operator and personnel from UV light. The curing tunnel may be non-insulated. It is not necessary to include an apparatus to draw off excess heat from the curing tunnel due to the pulsed UV lamp's capability to provide curing without heat build. This results in a further simplification of the process apparatus because no separate apparatus for moving air through or around the curing apparatus is required, thus eliminating the need for substantial amounts of equipment containing moving parts. Further advantages are realized by not needing to compensate for heat generated by the process by increasing load on HVAC environmental systems such as a central air conditioner.

Substantial benefits are achieved by using a pulsed UV curing process in comparison to a process which achieves curing with a continuous UV lamp. A pulsed UV lamp may be turned off and on without the necessity of any warm up or cool down cycle. Continuous UV lamps such as mercury vapor lamps may have a delay of as long as 20 minutes between shut off and restart. Therefore the process may be quickly stopped and started, and transitioning between marketable products and off-spec material is minimized between grades or during start up and shut down.

Importantly, because the process generates substantially less heat any risk or danger of overheating a sample to the point of combustion is minimized.

The process may be carried out in a continuous finishing system such as the model CTU curing system provided by Delle Vedove USA of Charlotte, N.C. Such a UV curing apparatus may accommodate a profile width of up to 300 mm and a maximum profile height of 60 mm when outfitted with a pulsed UV lamp as described above. Other systems that may be used include the UV drying/curing systems of Cerfla of High Point, N.C., such as the Cerfla UV2000 oven.

The invention includes an apparatus that may be used for carrying out the above-described process of the invention or other processes that use pulsed UV light. In one embodiment the apparatus contains at least one pulsed UV lamp. Preferably, the apparatus of the invention includes more than one pulsed UV lamp. For example, the apparatus of the invention may include two or more pulsed UV lamps arranged to expose all surfaces of a substrate undergoing treatment with pulsed UV light in the apparatus of the invention. For example, the pulsed UV lamps may be oriented 180 degrees apart from one another so that both a top surface and a bottom surface of a substrate undergoing curing are exposed to pulsed UV light.

In other embodiments, one or more additional lamps are arranged within the apparatus so that a three-dimensional shape such as a square-shaped tube is exposed equally on all four sides to thereby provide four equally cured surface coatings, e.g., all four sides are equally exposed to pulsed UV light when passing through the apparatus. Likewise, substrates that have an irregular form may be treated in an embodiment of the apparatus of the invention wherein plural UV lamps are arranged so that the shadowing of surfaces is avoided.

The pulsed UV lamps may be arranged in stages so that a first portion of a substrate, e.g., a top surface is first exposed to pulsed UV light to cure the coating present on the first surface where the first UV light is from a single pulsed UV lamp or first group of pulsed UV lamps. Subsequently, the lamp of a second stage containing one or more second pulsed UV lamps may be used in order to expose a second surface of the substrate in the apparatus. In this manner, the top and bottom surfaces of a flat substrate may be selectively cured in the apparatus of the invention.

Multiple pulsed UV lamps having different peak pulse power or pulse timing may be present in the apparatus to first provide a partial cure which is subsequently fully cured in a second or later stage with a lamp having a different UV power or a different pulsing sequence.

The apparatus of the invention is enclosed so that UV light does not escape the apparatus during use. Preferably no UV light from the pulsed UV lamps is detectable outside the apparatus. The apparatus may therefore include a removable cover which functions to block any reflected or emitted light from escaping the apparatus. It is further preferable that the pulsed UV lamps present inside the apparatus are shaded by hoods that direct and concentrate the pulsed UV light towards a substrate and/or curing chamber. A background which is UV absorptive may also be presenting the interior of the apparatus. By including a UV absorptive coating or layer on the inside walls of the apparatus which functions to absorb UV light, the emission of stray UV light can be minimized.

Optionally, the apparatus may include a device for filtering air or providing cooled or heated air. In one embodiment, a conditioned air stream duct is located inside the apparatus to blow a heated gas over a coated substrate before exposure to light from a pulsed UV lamp. The duct may be connected to the curing chamber (see below).

The apparatus is preferably capable of operating on a continuous basis to thereby provide a continuous length of, for example, a shaped molding have a cured coating. Therefore, the apparatus may include an exposure tunnel against which or inside of the UV which the pulsed lamps are positioned. The tunnel may further have a conveyor or table that functions to continuously move a substrate through the tunnel.

The apparatus of the invention may, of course, be connected to any number of additional upstream or downstream machines for handling any cured substrate or coated substrate prior to curing. For example, downstream of the pulsed UV lamp, e.g., after a substrate has been coated and cured with pulsed UV light, any number of machines for cutting, stacking, shaping, sanding, patterning, collecting, treating etc. may be interchangeably arranged and attached to the apparatus of the invention. Likewise, any number of additional machines for carrying out, e.g., coating by spraying, dipping, cutting, stacking, shaping, sanding, patterning, collecting, treating or any other pretreatment may be interchangeably connected with the apparatus of the invention. Preferably, any upstream or downstream apparatus connected to the apparatus of the invention is connected by a moving table or conveyor so that a substrate may move seamlessly, e.g., without interruption of forward motion, from one machine to the apparatus to another machine.

There is no restriction on the size or dimensions of the tunnel which may be used as a part of the apparatus and within which or inside of which the pulsed UV lamp(s) are positioned. The tunnel preferably has height and width dimensions of 100 mm×100 mm, preferably 200 mm×600 mm, more preferably 300 mm×800 mm. There is no restriction on the ultimate length or dimensions of the curing tunnel so long as there is sufficient space and surface area to position pulsed UV lamps to thereby expose a coated substrate and form a cured coated substrate.

In another embodiment, the apparatus of the invention is configured to carry out a batch operation. In a batch operation each coated substrate is cured individually or groups of coated substrates are cured at the same time. A batch apparatus may be configured so that curing can be undertaken in an atmosphere of reduced pressure. For example, the apparatus may contain a curing chamber which may be placed under partial vacuum such as 700 torr, 600 torr, 400 torr, 300 torr, 200 torr, 100 torr, 50 torr, 20 torr, 30 torr, 10 torr, 5 torr, 1 torr, and/or high vacuum of substantially lower pressure.

In another embodiment, the apparatus includes other curing devices in addition to pulsed UV lamps. For example, one or more IR lamps may be present. Additionally, a conventional UV lamp (e.g., a continuous UV lamp) may be present. Other types of curing such as by corona or gamma ray radiation may also be present in the apparatus of the invention. The additional sources of curing radiation may be connected to the tunnel and/or the chamber or alternately may be positions so that they are outside the tunnel and emit radiation (e.g., infra-red radiation) outside the apparatus.

1. A process, comprising:
coating a wood or a wood-containing substrate with a UV-curable coating material to form an uncured coated substrate;
exposing the uncured coated substrate to pulsed UV light to cure the UV-curable material and form a cured coated substrate.

2. The process according to claim 1, wherein the pulsed light has a peak power of from 200 to 2000 watts/cm² and a pulse duration of from 0.5 to 5 microseconds.

3. The process according to claim 2, wherein the uncured coated substrate is exposed to the pulsed UV light for from 0.1 to 10 seconds.

4. The process according to claim 1, wherein a coating is present on the surface of the cured coated substrate and is in continuous contact with the substrate.

5. The process according to claim 1, wherein the coating of the cured coated substrate consists of the cured UV-curable coating material.

6. The process according to claim 1, wherein the temperature measured at the interface between the wood substrate and the coating of the cured coated substrate rises no greater than 20° C. during or upon complete exposure of the uncured coated substrate to pulsed the UV light based on the temperature before exposure to the UV light.

7. The process according to claim 1, wherein the pulsed UV light includes UV light having a wavelength of from 160 to 700 nm.

8. The process according to claim 1, wherein the wood substrate is in the form of a molding or a flat panel.

9. The process according to claim 1, wherein the wood substrate is a laminate of two wood-containing layers adhered to one another with an adhesive.

10. A coating obtained by the process of claim 1.

11. A wood substrate having a coating obtained by the process of claim 1.

12. A curing apparatus, comprising:
at least one pulsed UV lamp,
a curing chamber or curing tunnel, and
at least one fixture for mounting the pulsed UV lamp,
wherein each pulsed UV lamps is positioned on a fixture inside the chamber or tunnel to permit expose the interior of the chamber or tunnel with pulsed UV light.
